(19) United States
(12) Patent Application Publication
(10) Pub. No.: US 2012/0203421 A1
(43) Pub. Date: Aug. 9, 2012

(54) DATA ASSOCIATION FOR VEHICLES

(75) Inventor: Vernon L. NEWHOUSE, Farmington, MI (US)

(73) Assignee: GM GLOBAL TECHNOLOGY OPERATIONS LLC, DETROIT, MI (US)

(21) Appl. No.: 13/022,442

(22) Filed: Feb. 7, 2011

(51) Int. Cl. G06F 7/00

(52) U.S. Cl. 701/29.1; 701/29.6; 701/31.4

(57) ABSTRACT

Methods, systems, and program products for associating data for a vehicle are provided. On-vehicle data pertaining to operation of the vehicle is obtained. Off-vehicle data pertaining to a condition that is irrespective of the operation of the vehicle is also obtained. A determination is made that an event has occurred using the on-vehicle data. An association is generated between the event and the condition using the off-vehicle data.

### STATEMENT REGARDING FEDERALLY SPONSORED RESEARCH OR DEVELOPMENT

This invention was made with Government support under Agreement DE-FC26-08NT04386, awarded by the US-Department of Energy. The Government has certain rights in this invention.

### TECHNICAL FIELD

The present disclosure generally relates to the field of vehicles and, more specifically, to methods and systems for associating data for vehicles.

### BACKGROUND

Automobiles and various other vehicles often generate and record data pertaining to the operation of the vehicles or systems thereof. For example, if an error or other event occurs during operation of the vehicle, an occurrence of the event may be recorded. However, for certain events, it may be difficult to subsequently obtain additional information pertaining to the events. For example, if an error occurs during the charging of an electric vehicle or a hybrid electric vehicle, the error may not be known to the owner or operator of the vehicle until the next time that the vehicle is driven.

Accordingly, it is desirable to provide an improved method for providing additional information regarding vehicle events, for example during charging of an electric or hybrid electric vehicle. It is also desirable to provide improved program products and systems for providing additional information regarding vehicle events, for example during charging of an electric or hybrid electric vehicle. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method for associating data for a vehicle is provided. The method comprises the steps of obtaining on-vehicle data pertaining to operation of the vehicle, obtaining off-vehicle data pertaining to a condition that is irrespective of the operation of the vehicle, determining that an event has occurred using the on-vehicle data, and associating the event with the condition using the off-vehicle data via a processor.

In accordance with another exemplary embodiment, a program product for associating data for a vehicle is provided. The program product comprises a program and a non-transitory, signal-bearing, computer readable storage medium. The program is configured to obtain on-vehicle data pertaining to operation of the vehicle, obtain off-vehicle data pertaining to a condition that is irrespective of the operation of the vehicle, determine that an event has occurred using the on-vehicle data, and associate the event with the condition using the off-vehicle data. The non-transitory, signal-bearing, computer readable storage medium stores the program.

In accordance with a further exemplary embodiment, a system for associating data for a vehicle is provided. The system comprises a processor and a memory. The processor is configured to obtain on-vehicle data pertaining to operation of the vehicle, obtain off-vehicle data pertaining to a condition that is irrespective of the operation of the vehicle, determine that an event has occurred using the on-vehicle data, and associate the event with the condition using the off-vehicle data, to generate an association between the event and the condition. The memory stores the association between the event and the condition.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a system for a vehicle, such as an automobile, that associates vehicle events with non-vehicle conditions, in accordance with an exemplary embodiment; and

FIG. 2 is a flowchart of a process for associating vehicle events with non-vehicle conditions, and that can be utilized in connection with the system of FIG. 1, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

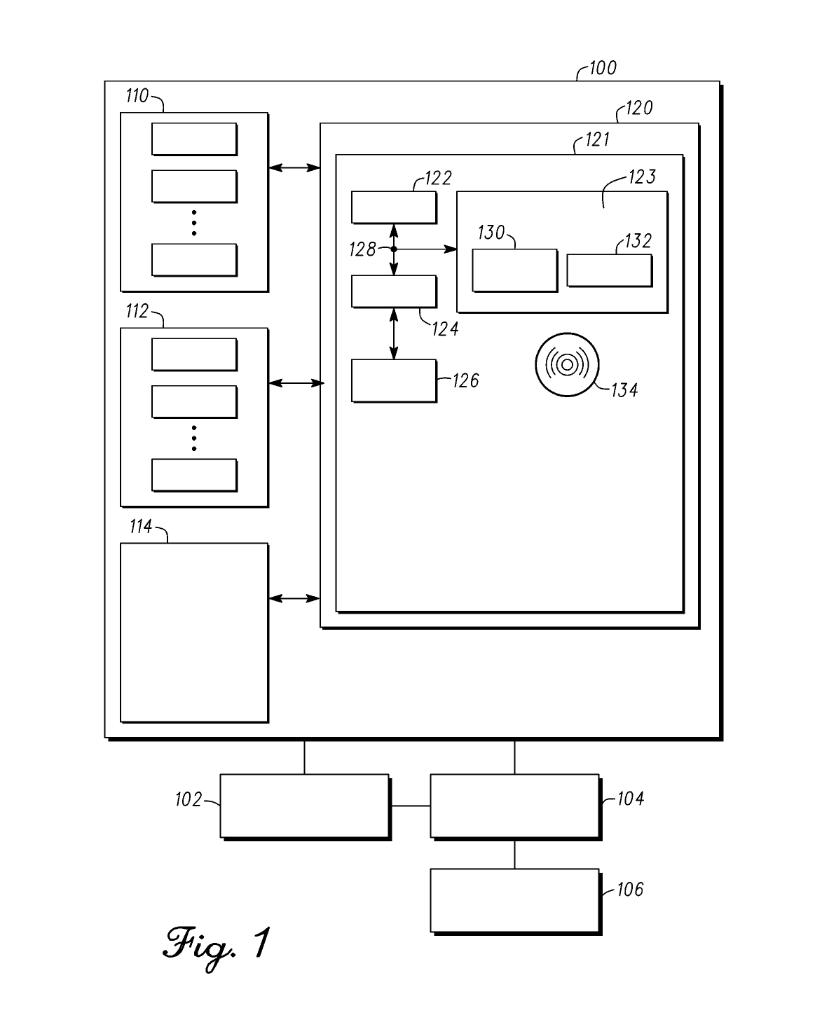

FIG. 1 is a block diagram of an exemplary system 100 for use in a vehicle. In a preferred embodiment, the vehicle comprises an automobile, such as a sedan, a sport utility vehicle, a van, or a truck. However, the type of vehicle may vary in different embodiments.

The system 100 associates vehicle events with non-vehicle conditions for use in the vehicle. The system 100 also preferably performs, or facilitates the performance of, one or more vehicle functions. Specifically, in the depicted embodiment, the vehicle comprises an electric vehicle or a hybrid electric vehicle (collectively referred to as an “electric vehicle” hereafter in this application). The electric vehicle includes a battery 102 that is charged via a charger 104 that is plugged into an electric grid 106. The system 100 is coupled to the battery 102 and the charger 104, and provides instructions for charging the battery 102 via the charger 104 and the electric grid 106.

As depicted in FIG. 1, the system 100 includes one or more sensors 110, one or more transceivers 112, a timer 114, and a controller 120. The sensors 110 are coupled to the controller 120. The sensors 110 include one or more sensors that are configured to obtain measurements pertaining to off-vehicle data, and one or more sensors that are configured to obtain measurements pertaining to on-vehicle data. As used throughout this application, “on-vehicle” data pertains to operation of the vehicle, and “off-vehicle” data pertains to one or more conditions that are irrespective or independent of the operation of the vehicle. In one preferred embodiment, the on-vehicle data pertains to whether the vehicle is being operated or driven, a velocity of the vehicle, an engine temperature of the vehicle, a cabin temperature of the vehicle, a state of charge of the battery 102, an operational state of the charger 104, and the like. Also in one preferred embodiment, the off-vehicle data pertains to a date, a time of day, an ambient temperature, and/or one or more other off-vehicle environmental conditions, such as ambient humidity, and the like.

The sensors 110 preferably include an ambient temperature sensor 110 that is disposed on an exterior portion of the vehicle. Other sensors 110, such as other temperature sensors, humidity sensors, pressure sensors, and/or one or more other types of sensors may also be utilized for other off-vehicle data pertaining to other types of environmental conditions outside the vehicle. In addition, certain of the sensors 110 are configured to measure various types of on-vehicle data (including on-vehicle data pertaining to the battery 102 and the charger 104, such as a state of charge of the battery 102 and a status of the charger 104), for use in determining whether one or more events have occurred for the vehicle. The measurements from the sensors 110 and/or information pertaining thereto are provided by the sensors 110 to the controller 120 for processing and for associating data for the vehicle. The number and/or types of sensors 110 may vary in different embodiments.

The one or more transceivers 112 are coupled to the controller 120. The transceivers 112 receive information pertaining to various off-vehicle data. Specifically, in one embodiment, the transceivers 112 receive data pertaining to a date and a time of day. In addition, in certain embodiments, the transceivers 112 also receive data pertaining to an ambient temperature outside the vehicle, and/or regarding other weather conditions and/or other types of environmental conditions. The data from the transceivers 112 and/or information pertaining thereto are provided by the transceivers 112 to the controller 120 for processing and for associating data for the vehicle. In one embodiment, the transceivers 112 comprise a global positioning system (GPS) transceiver 112 and a cellular transceiver 112. In certain embodiments, the transceivers 112 may comprise separate receivers and/or transmitters (rather than having both a receiver and a transmitter together as a single transceiver), and/or the transceivers 112 may comprise one or more other types of transceivers. In addition, the number and/or types of transceivers 112 may vary in different embodiments.

The timer 114 is coupled to the controller 120. The timer 114 receives and/or generates information pertaining to certain off-vehicle data pertaining to a date and a time of day. Specifically, in one embodiment, the timer 114 generates an offset for date and time data received by the transceivers 112, for use by the controller 120 in calculating the date and the time of day. The data from the timer 114 and/or information pertaining thereto are provided by the timer 114 to the controller 120 for processing and for associating data for the vehicle. The number and/or types of timers 114 may vary in different embodiments.

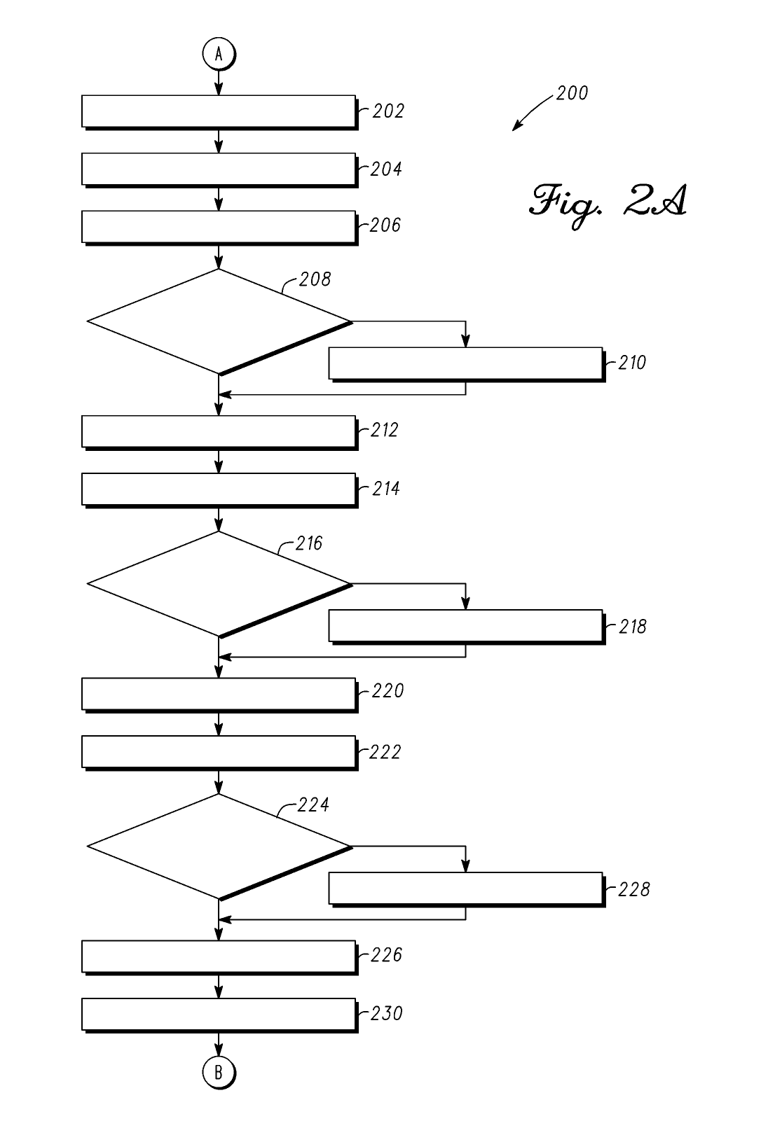

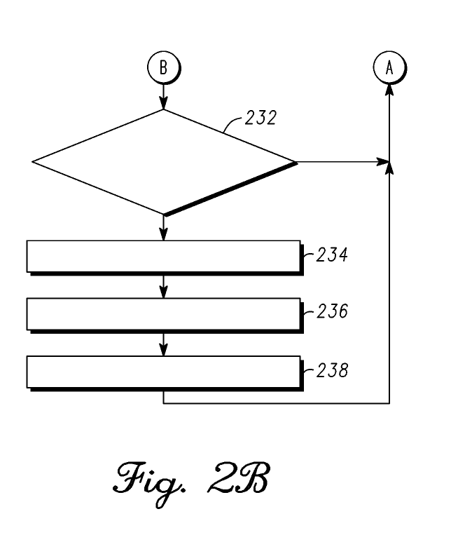

The controller 120 is coupled to the sensors 110, the transceivers 112, and the timer 114. In addition, in the depicted embodiment, the controller 120 is also coupled to the battery 102 and the charger 104. The controller 120 controls operation of one or more vehicle functions. In the depicted embodiment, the controller 120 provides instructions for the charging of the battery 102 using the charger 104 and the electric grid 106. In addition, the controller 120 is configured to obtain the various off-vehicle data and on-vehicle data from the sensors 110, the transceivers 112, and the timer 114, process the on-vehicle data in order to determine one or more events associated with the vehicle (such as an error or failure in charging the battery 102 of the vehicle), process the off-vehicle data to generate information as to one or more conditions (such as the date, the time of day, the ambient temperature, and/or one or more other environmental conditions), and associate the conditions with the events for storage, transmission, and subsequent use in performing diagnostics and/or remedial actions for the vehicle. The controller 120 preferably performs these functions in accordance with the steps of the process 200 depicted in FIG. 2 and described further below in connection therewith.

In the depicted embodiment, the controller 120 comprises a computer system 121. In certain embodiments, the controller 120 may also include one or more of the sensors 110, the transceivers 112, and/or the timer 114, among other possible variations. In addition, it will be appreciated that the controller 120 may otherwise differ from the embodiment depicted in FIG. 1, for example in that the controller 120 may be coupled to or may otherwise utilize one or more remote computer systems and/or other control systems.

In the depicted embodiment, the computer system 121 is coupled to the sensors 110, the transceivers 112, the timer 114, the battery 102, and the charger 104. The computer system 121 performs the functions of the controller 120, for example in receiving signals or information from the various sensors 110, the transceivers 112, and the timer 114 pertaining to on-vehicle data and off-vehicle data, processing these signals or information, controlling the charging of the battery 102, determining the occurrence of one or more vehicle events using the on-vehicle data, determining one or more conditions using the off-vehicle data, and associating the vehicle events with the conditions. In a preferred embodiment, these and other functions are conducted in accordance with the process 200 depicted in FIG. 2 and described further below in connection therewith.

In the depicted embodiment, the computer system 121 includes a processor 122, a memory 123, an interface 124, a storage device 126, and a bus 128. The processor 122 performs the computation and control functions of the computer system 121 and the controller 120, and may comprise any type of processor or multiple processors, single integrated circuits such as a microprocessor, or any suitable number of integrated circuit devices and/or circuit boards working in cooperation to accomplish the functions of a processing unit. During operation, the processor 122 executes one or more programs 130 contained within the memory 123 and, as such, controls the general operation of the controller 120 and the computer system 121, preferably in executing the steps of the processes described herein, such as the process 200 depicted in FIG. 2 and described further below in connection therewith.

The memory 123 can be any type of suitable memory. This would include the various types of dynamic random access memory (DRAM) such as SDRAM, the various types of static RAM (SRAM), and the various types of non-volatile memory (PROM, EPROM, and flash). The bus 128 serves to transmit programs, data, status and other information or signals between the various components of the computer system 121. In a preferred embodiment, the memory 123 stores the above-referenced program 130 along with one or more stored values 132 that are used in controlling the charging of the battery 102 and/or associating data for the vehicle in accordance with steps of the process 200 depicted in FIG. 2 and described further below in connection therewith. In certain examples, the memory 123 is located on and/or co-located on the same computer chip as the processor 122.

The interface 124 allows communication to the computer system 121, for example from a system driver and/or another computer system, and can be implemented using any suitable method and apparatus. It can include one or more network interfaces to communicate with other systems or components. The interface 124 may also include one or more network interfaces to communicate with technicians, and/or one or more storage interfaces to connect to storage apparatuses, such as the storage device 126.

The storage device 126 can be any suitable type of storage apparatus, including direct access storage devices such as hard disk drives, flash systems, floppy disk drives and optical disk drives. In one exemplary embodiment, the storage device 126 comprises a program product from which memory 123 can receive a program 130 that executes one or more embodiments of one or more processes of the present disclosure, such as the process 200 of FIG. 2 or portions thereof. In another exemplary embodiment, the program product may be directly stored in and/or otherwise accessed by the memory 123 and/or a disk (e.g. disk 134), such as that referenced below.

The bus 128 can be any suitable physical or logical means of connecting computer systems and components. This includes, but is not limited to, direct hard-wired connections, fiber optics, infrared and wireless bus technologies. During operation, the program 130 is stored in the memory 123 and executed by the processor 122.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 122) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system 121 may also otherwise differ from the embodiment depicted in FIG. 1, for example in that the computer system 121 may be coupled to or may otherwise utilize one or more remote computer systems and/or other control systems.

FIG. 2 is a flowchart of a process 200 for associating vehicle events with non-vehicle conditions, in accordance with an exemplary embodiment. The process 200 can preferably be utilized in connection with the system 100 of FIG. 1, the controller 120, and/or the computer system 121 of FIG. 1, in accordance with an exemplary embodiment.

As depicted in FIG. 2, the process 200 includes the step of controlling one or more vehicle functions (step 202). In a preferred embodiment, step 202 includes control of the charging of the battery 102 of FIG. 1. This step is preferably conducted by the controller 120 of FIG. 1, most preferably by the processor 122 thereof.

In addition, various on-vehicle data is obtained (step 204). As mentioned above, as referenced throughout this application, “on-vehicle” data pertains to operation of the vehicle. The on-vehicle data of step 204 preferably pertains to internal vehicle data, such as a state of charge of the battery 102 of FIG. 1 and an operational state of the charger 104 of FIG. 1. The on-vehicle data of step 204 is preferably obtained via one or more of the sensors 110 of FIG. 1 and provided to the controller 120 of FIG. 1, most preferably by the processor 122 thereof, for processing.

The on-vehicle data from step 204 is then verified (step 206). The verification of step 206 pertains to whether the on-vehicle data of step 204 represents valid, reliable data. For example, in one embodiment, the verification of step 206 pertains to whether the on-vehicle data of step 204 is within normally acceptable maximum and/or minimum bounds. The verification of step 206 is preferably conducted by the controller 120 of FIG. 1, most preferably by the processor 122 thereof.

As a result of the verification of step 206, a determination is made as to whether the on-vehicle data from step 204 is valid (step 208). This determination is preferably made by the controller 120 of FIG. 1, most preferably by the processor 122 thereof. If it is determined in step 208 that the on-vehicle data of step 204 is valid, then the process proceeds directly to step 212, described below. Conversely, if it is determined in step 208 that the on-vehicle data of step 204 is invalid, then an invalidity notation or message is generated for the on-vehicle data of step 204 (step 210), and the process then proceeds to step 212. The invalidity notation or message of step 210 is preferably generated by the controller 120 of FIG. 1, most preferably by the processor 122 thereof.

During the above-mentioned step 212, a first type of off-vehicle data is obtained. As mentioned above, as referenced throughout this application, “off-vehicle” data pertains to a condition that is independent or irrespective of the operation of the vehicle. The off-vehicle data of step 212 preferably pertains to date and time data, such as the current year, month, date, and time of day. The date and time data of step 212 is preferably obtained via the transceivers 112 and/or the timer 114 of FIG. 1 and provided to the controller 120 of FIG. 1, most preferably to the processor 122 thereof, for processing.

Specifically, in one preferred embodiment, during step 212 certain transceivers 112 of FIG. 1 provide a first, or general, measure of the date and time, certain other transceivers 112 of FIG. 1 provide a second, or intermediate, measure of the date and time, and the timer 114 of FIG. 1 provides an offset for the first and second measures of the date and time. In one such embodiment, a GPS transceiver 112 of FIG. 1 receives a first, global, date and time data value via a GPS network, such as a value of Greenwich Mean Time at a particular point in time. In addition, a cellular transceiver 112 of FIG. 1 receives a second, local date and time data adjustment value from a cellular network and/or central server, such as an adjustment to the Greenwich Mean Time to account for the particular time zone in which the vehicle is currently located. The timer 114 of FIG. 1 tracks an amount of time since the particular point of time at which the first and second date and time data values were obtained, to thereby generate an offset for the first and second date and time data values.

The date and time data from step 212 is then verified (step 214). The verification of step 214 pertains to whether the date and time data of step 212 represents valid, reliable data. For example, in one embodiment, the verification of step 214 pertains to whether the date and time data of step 212 is within normally acceptable maximum and/or minimum bounds. The verification of step 214 is preferably conducted by the controller 120 of FIG. 1, most preferably by the processor 122 thereof.

As a result of the verification of step 214, a determination is made as to whether the date and time data from step 212 is valid (step 216). This determination is preferably made by the controller 120 of FIG. 1, most preferably by the processor 122 thereof. If it is determined in step 216 that the date and time data of step 212 is valid, then the process proceeds directly to step 220, described below. Conversely, if it is determined in step 216 that the date and time data of step 212 is invalid, then an invalidity notation or message is generated for the date and time data of step 212 (step 218), and the process then proceeds to step 220. The invalidity notation or message of step 218 is preferably generated by the controller 120 of FIG. 1, most preferably by the processor 122 thereof.

During the above-mentioned step 220, a second type of off-vehicle data is obtained. The off-vehicle data of step 220 preferably pertains to environmental condition data, such as an ambient temperature outside the vehicle. The environmental condition data of step 220 is preferably obtained via one or more sensors 110 of FIG. 1 and provided to the controller 120 of FIG. 1, most preferably by the processor 122 thereof, for processing. In certain embodiments, the environmental condition data of step 220 may be obtained in whole or in part by the transceivers 112 and/or the timer 114 of FIG. 1, instead of or in addition to the sensors 110 of FIG. 1, and provided to the controller 120 of FIG. 1, most preferably by the processor 122 thereof, for processing.

The environmental condition data from step 220 is then verified (step 222). The verification of step 222 pertains to whether the environmental condition data of step 220 represents valid, reliable data. For example, in one embodiment, the verification of step 222 pertains to whether the environmental condition data of step 220 is within normally acceptable maximum and/or minimum bounds. The verification of step 222 is preferably conducted by the controller 120 of FIG. 1, most preferably by the processor 122 thereof.

As a result of the verification of step 222, a determination is made as to whether the environmental condition data from step 220 is valid (step 224). This determination is preferably made by the controller 120 of FIG. 1, most preferably by the processor 122 thereof. If it is determined in step 224 that the environmental condition data of step 220 is valid, then the process proceeds directly to step 226, described below. Conversely, if it is determined in step 224 that the environmental condition data of step 220 is invalid, then an invalidity notation or message is generated for the environmental condition data of step 220 (step 228), and the process then proceeds to step 226. The invalidity notation or message of step 228 is preferably generated by the controller 120 of FIG. 1, most preferably by the processor 122 thereof.

During the above-referenced step 226, the on-vehicle data of step 204 is processed. The on-vehicle data of step 204 is preferably processed by the controller 120 of FIG. 1, most preferably by the processor 122 thereof. Specifically, the on-vehicle data of step 204 is processed in order to make various determinations regarding operation of the vehicle, for example as to the charging of the battery 102 of FIG. 1, while the functions of step 202 (such as charging the vehicle battery) are being performed.

In addition, the off-vehicle data is also processed (step 230). The date and time data of step 212 and the environmental condition data of step 220 are preferably processed by the controller 120 of FIG. 1, most preferably by the processor 122 thereof. Specifically, the date and time data of step 212 and the environmental condition data of step 220 are processed in order to make various determinations regarding conditions surrounding the vehicle while the functions of step 202 are being performed. In one preferred embodiment, the first date and time data (from a GPS transceiver 112 of FIG. 1), the second date and time data (from a cellular transceiver 112 of FIG. 1) and the date and time offset (from the timer 114 of FIG. 1) of step 212 are combined and processed in step 230 in order to determine an accurate, real-time measure of the date and time, preferably continuously, for the vehicle.

A determination is made as to whether a vehicle event has occurred (step 232). A vehicle event preferably comprises an event pertaining to operation of the vehicle. Preferably, the vehicle event pertains to the vehicle function of step 202. For example, in one preferred embodiment in which the function of step 202 comprises charging the battery 102 of FIG. 1, a vehicle event may comprise an error or fault in the charging of the battery 102, a break in connection between the battery 102 and the charger 104 of FIG. 1 and/or between the charger 104 and the electric grid 106 of FIG. 1, an interruption of power for the electric grid 106, and the like. The determination of step 232 is preferably made by the controller 120 of FIG. 1, most preferably by the processor 122 thereof, using information provided by one or more of the sensors 110 of FIG. 1.

If it is determined in step 232 that a vehicle event has not occurred, then the process returns to step 202. Steps 202-232 then repeat, preferably continuously, in various iterations until a determination is made in a subsequent iteration of step 232 that a vehicle event has occurred.

Once it is determined in an iteration of step 232 that a vehicle event has occurred, then the off-vehicle data and the on-vehicle data are associated with one another (step 234). Specifically, the conditions represented by the date and time data of step 212 and the environmental condition data of step 220 (preferably, as determined via the processing of step 230, described above) are associated with the vehicle event that was determined from the on-vehicle data of step 204 (preferably, as determined during the processing of step 226 and the determination of step 232). Accordingly, during step 234, the vehicle event is associated with, or “stamped” with, real-time values of the particular date and time at which the event occurred, along with the ambient temperature surrounding the vehicle when the vehicle event occurred, and/or other environmental conditions that were prevalent when the vehicle event occurred.

The associated data is then recorded (step 236). Preferably, the association (or “stamp”) between the vehicle event, the date and time, the ambient temperature, and/or other environmental conditions are stored in the memory 123 of FIG. 1 as stored values 132 therein. In certain embodiments, the associated data may be transmitted to a central server and/or to one or more other locations via the transceivers 112 of FIG. 1.

Diagnostics may then be performed using the associated data (step 238). For example, given the additional information regarding the date and time, the ambient temperature, and/or the other environmental conditions that were prevalent outside the vehicle when the event occurred, this information may be utilized in ascertaining patterns in the occurrence of events for the vehicle and/or among various different vehicles. This can also be utilized in determining root causes for the events, as well as in ascertaining information as to how to prevent such events from occurring and/or as to how best to remedy such events once they occur for the vehicle.

In certain embodiments, the diagnostics of step 238 may be performed by the controller 120 of FIG. 1, most preferably by the processor 122 thereof. In certain other embodiments, the diagnostics of step 238 may be performed by one or more other processors, for example one or more processors of a central server that may have received the associated data from the transceivers 112 of FIG. 1. Steps 202-238 preferably then repeat, most preferably, continuously, as the vehicle functions continue to be performed, and as additional on-vehicle and off-vehicle data continue to be obtained and processed. To that end, the steps of the process 200 of FIG. 2 are preferably performed continuously in real time, to thereby obtain, process, and utilize the on-vehicle and off-vehicle data continuously in real time.

Accordingly, improved methods, program products, and systems are provided for associating data in vehicles. The improved methods, program products, and systems provide for improved associating of the occurrence of vehicle events with real-time date and time data as well as other real-time data pertaining to conditions that were prevalent outside the vehicle data when the vehicle event occurred. As a result, this provides additional information pertaining to patterns of and/causes pertaining to the vehicle event, which can in turn be utilized in diagnosing, preventing, and/or remedying such vehicle events in the future. This can be particularly beneficial for certain types of vehicle functions, such as charging a battery of an electric vehicle, in which failures, errors or other events may occur at any time, even when the vehicle is not being operated by a user. Accordingly, for example, even if a vehicle operator does not become aware of such an error, failure, or other vehicle event until a later time, the vehicle event is effectively stamped or associated with a date, a time, an ambient temperature, and/or data pertaining to other conditions outside the vehicle at the time of the occurrence of the event. This information can then be stored, transmitted, and subsequently utilized in diagnosing, preventing, and remedying the vehicle event.

It will be appreciated that the disclosed methods and systems may vary from those depicted in the Figures and described herein. For example, as mentioned above, the controller 120 of FIG. 1 may be disposed in whole or in part in any one or more of a number of different vehicle units, devices, and/or systems. In addition, it will be appreciated that certain steps of the process 200 may vary from those depicted in FIG. 2 and/or described above in connection therewith. It will similarly be appreciated that certain steps of the process 200 may occur simultaneously or in a different order than that depicted in FIG. 2 and/or described above in connection therewith. It will similarly be appreciated that the disclosed methods and systems may be implemented and/or utilized in connection with any number of different types of automobiles, sedans, sport utility vehicles, trucks, and/or any of a number of other different types of vehicles, and in controlling any one or more of a number of different types of vehicle infotainment systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A method of associating data for a vehicle, the method comprising the steps of:
obtaining on-vehicle data pertaining to operation of the vehicle;
obtaining off-vehicle data pertaining to a condition that is irrespective of the operation of the vehicle;
determining that an event has occurred using the on-vehicle data; and
associating the event with the condition using the off-vehicle data via a processor.

2. The method of claim 1, wherein the condition comprises a date at which the event occurred.

3. The method of claim 1, wherein the condition comprises a time of day at which the event occurred.

4. The method of claim 1, wherein the condition comprises an ambient temperature at which the event occurred.

5. The method of claim 1, wherein:
the vehicle is an electric vehicle; and
the event pertains to a failure that has occurred during charging of the electric vehicle.

6. The method of claim 1, wherein an association between the event and the condition is generated via the step of associating the event with the condition, and the method further comprises the step of:
storing the association between the event and the condition in a memory.

7. The method of claim 6, further comprising the step of:
conducting diagnostics for the vehicle using the association between the event and the condition.

8. A program product for associating data for a vehicle, the program product comprising:
a program configured to:
obtain on-vehicle data pertaining to operation of the vehicle;
obtain off-vehicle data pertaining to a condition that is irrespective of the operation of the vehicle;
determine that an event has occurred using the on-vehicle data; and
associate the event with the condition using the off-vehicle data; and
a non-transitory, signal-bearing, computer readable storage medium storing the program.

9. The program product of claim 8, wherein the condition comprises a date at which the event occurred.

10. The program product of claim 8, wherein the condition comprises a time of day at which the event occurred.

11. The program product of claim 8, wherein the condition comprises an ambient temperature at which the event occurred.

12. The program product of claim 8, wherein:
the vehicle is an electric vehicle; and
the event pertains to a failure that has occurred during charging of the electric vehicle.

13. The program product of claim 8, wherein the program is further configured to:
generate an association between the event and the condition; and
store the association between the event and the condition.

14. The program product of claim 13, wherein the program is further configured to:
conduct diagnostics for the vehicle using the association between the event and the condition.

15. A system for associating data for a vehicle, the system comprising:
a processor configured to:
obtain on-vehicle data pertaining to operation of the vehicle;
obtain off-vehicle data pertaining to a condition that is irrespective of the operation of the vehicle;
determine that an event has occurred using the on-vehicle data; and
associate the event with the condition using the off-vehicle data, to generate an association between the event and the condition; and
a memory coupled to the processor and configured to store the association between the event and the condition.

16. The system of claim 15, wherein the condition comprises a date at which the event occurred.

17. The system of claim 15, wherein the condition comprises a time of day at which the event occurred.

18. The system of claim 15, wherein the condition comprises an ambient temperature at which the event occurred.

19. The system of claim 15, wherein:
the vehicle is an electric vehicle; and
the event pertains to a failure that has occurred during charging of the electric vehicle.

20. The system of claim 15, wherein the processor is further configured to conduct diagnostics for the vehicle using the association between the event and the condition.
